(19) United States
(12) Patent Application Publication
(10) Pub. No.: US 2026/0166938 A1
(43) Pub. Date: Jun. 18, 2026

(54) LEAF SPRING SHACKLE

(71) Applicant: GM Global Technology Operations LLC, Detroit, MI (US)

(72) Inventors: Douglas Arbour, Brighton, MI (US); Dominick Sterley, White Lake, MI (US)

(21) Appl. No.: 18/982,751

(22) Filed: Dec. 16, 2024

(51) Int. Cl. B60G 11/36; B60G 13/00; B60G 13/08

(52) U.S. Cl. CPC B60G 11/36; B60G 13/003; B60G 13/08; B60G 2202/114; B60G 2202/24; B60G 2202/31; B60G 2204/43; B60G 2206/72

(57) ABSTRACT

A leaf spring shackle for a vehicle includes an upper bracket adapted to be pivotally connected to a distal end of a leaf spring, a lower bracket adapted to be pivotally connected to a frame component of the vehicle, and a linear dampening member positioned between the upper bracket and the lower bracket, and wherein, the upper bracket and the lower bracket are pivotally connected to one another and the linear dampening member is adapted to dampen pivotal movement of the upper bracket relative to the lower bracket.

### INTRODUCTION

The present invention relates generally to a leaf spring shackle for a vehicle. A leaf spring shackle attaches one end of a leaf spring to the frame of a vehicle. A leaf spring suspension includes leaf springs that position and support the axle under the vehicle, and support the weight of the vehicle. As a leaf spring flexes up or down, its length from eye to eye changes. Since typically a first end of a leaf spring is mounted stationary to the frame of the vehicle, and cannot move, all length change happens at the opposite second end of the lead spring, wherein a leaf spring shackle is positioned between and interconnects the second end of the leaf spring to the frame of the vehicle. Such leaf spring shackles generally include a first pivotal connection between the leaf spring and the leaf spring shackle, and a second pivotal connection between the leaf spring shackle and the frame of the vehicle. The first and second pivotal connections are spaced from one another and allow movement of the second end of the leaf spring in both an x-direction (forward and backward) and a z-direction (up and down).

Thus, while current leaf spring shackles achieve their intended purpose, there is a need for a new and improved leaf spring shackle that includes a third pivotal connection and uses linear dampening to provide improved suspension characteristics.

### SUMMARY

According to several aspects of the present disclosure, a leaf spring shackle for a vehicle includes an upper bracket adapted to be pivotally connected to a distal end of a leaf spring, a lower bracket adapted to be pivotally connected to a frame component of the vehicle, and a linear dampening member positioned between the upper bracket and the lower bracket, and wherein, the upper bracket and the lower bracket are pivotally connected to one another and the linear dampening member is adapted to dampen pivotal movement of the upper bracket relative to the lower bracket.

According to another aspect, the upper bracket is adapted to be pivotally connected to the distal end of the leaf spring at a first pivotal connection, wherein the upper bracket is pivotally moveable relative to the distal end of the leaf spring about a first axis, the lower bracket is adapted to be pivotally connected to the frame component of the vehicle at a second pivotal connection, wherein the lower bracket is pivotally moveable relative to the frame of the vehicle about a second axis, and the upper bracket and the lower bracket are pivotally connected to one another at a third pivotal connection and are pivotally moveable relative to one another about a third axis.

According to another aspect, the upper bracket includes a first end and a second end, the first pivotal connection adjacent the first end of the upper bracket, the lower bracket includes a first end and a second end, the second pivotal connection adjacent the first end of the lower bracket, the third pivotal connection located between the first and second end of the upper bracket and between the first and second end of the lower bracket, wherein, movement of the first end of the upper bracket away from the first end of the lower bracket pivots the upper backet and the lower bracket relative to one another and moves the second end of the upper bracket toward the second end of the lower bracket.

According to another aspect, the linear dampening member is positioned between the second end of the upper bracket and the second end of the lower bracket and is adapted to dampen movement of the second end of the upper bracket toward the second end of the lower bracket, dampening movement of the first end of the upper bracket away from the first end of the lower bracket.

According to another aspect, the first end of the upper bracket is pivotal about the first axis and moveable in both an x-direction, forward and backward, and a z-direction, up and down, the first end of the lower bracket is pivotal about the second axis and held stationary in both the x-direction and the z-direction, and the third pivotal connection between the upper bracket and the lower bracket is moveable in both the x-direction and the z-direction.

According to another aspect, the linear dampening member includes a coil spring positioned between the second end of the upper bracket and the second end of the lower bracket, and a dampener positioned within the coil spring between the second end of the upper bracket and the second end of the lower bracket.

According to another aspect, the coil spring is made from steel.

According to another aspect, the dampener includes a first component made from a dampening material and a second component made from an energy absorbing material.

According to another aspect, the first component of the dampener is a cylindrical tower positioned within the coil spring and made from thermoplastic urethane and the second component of the dampener is a column positioned within the cylindrical tower and made from microcellular urethane.

According to another aspect, the dampener comprises a hydraulic shock absorber.

According to another aspect, movement of the second end of the upper bracket toward the second end of the lower bracket linearly compresses the linear dampening member.

According to another aspect, the upper bracket and the lower bracket are stamped steel components.

According to several aspects of the present disclosure, a leaf spring assembly for a vehicle includes a leaf spring, and a leaf spring shackle adapted to connect the leaf spring to a frame component of the vehicle, the leaf spring shackle including a stamped steel upper bracket adapted to be pivotally connected to a distal end of the leaf spring, a stamped steel lower bracket adapted to be pivotally connected to a frame component of the vehicle, and a linear dampening member positioned between the upper bracket and the lower bracket, and wherein, the upper bracket and the lower bracket are pivotally connected to one another and the linear dampening member is adapted to dampen pivotal movement of the upper bracket relative to the lower bracket.

According to another aspect, the upper bracket is adapted to be pivotally connected to the distal end of the leaf spring at a first pivotal connection, wherein the upper bracket is pivotally moveable relative to the distal end of the leaf spring about a first axis, the lower bracket is adapted to be pivotally connected to the frame component of the vehicle at a second pivotal connection, wherein the lower bracket is pivotally moveable relative to the frame of the vehicle about a second axis, and the upper bracket and the lower bracket are pivotally connected to one another at a third pivotal connection and are pivotally moveable relative to one another about a third axis.

According to another aspect, the upper bracket includes a first end and a second end, the first pivotal connection adjacent the first end of the upper bracket, the lower bracket includes a first end and a second end, the second pivotal connection adjacent the first end of the lower bracket, the third pivotal connection located between the first and second end of the upper bracket and between the first and second end of the lower bracket, wherein, movement of the first end of the upper bracket away from the first end of the lower bracket pivots the upper backet and the lower bracket relative to one another and moves the second end of the upper bracket toward the second end of the lower bracket.

According to another aspect, the linear dampening member is positioned between the second end of the upper bracket and the second end of the lower bracket, wherein movement of the second end of the upper bracket toward the second end of the lower bracket linearly compresses the linear dampening member and the linear dampening member is adapted to linearly dampen movement of the second end of the upper bracket toward the second end of the lower bracket, dampening movement of the first end of the upper bracket away from the first end of the lower bracket.

According to another aspect, the first end of the upper bracket is pivotal about the first axis and moveable in both an x-direction, forward and backward, and a z-direction, up and down, the first end of the lower bracket is pivotal about the second axis and held stationary in both the x-direction and the z-direction, and the third pivotal connection between the upper bracket and the lower bracket is moveable in both the x-direction and the z-direction, wherein the linear dampening member includes a steel coil spring positioned between the second end of the upper bracket and the second end of the lower bracket, and a dampener positioned within the coil spring between the second end of the upper bracket and the second end of the lower bracket.

According to another aspect, the dampener includes a cylindrical tower positioned within the coil spring and made from thermoplastic urethane and a column positioned within the cylindrical tower and made from microcellular urethane.

According to yet another aspect, the dampener comprises a hydraulic shock absorber.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of a vehicle according to an exemplary embodiment of the present disclosure;

FIG. 2 is a perspective view of a leaf spring supported on a frame component of a vehicle by a leaf spring shackle in accordance with an exemplary embodiment of the present disclosure;

FIG. 3A is a perspective view of a leaf spring shackle having a linear dampener including a first component and a second component;

FIG. 3B is a perspective view of a leaf spring shackle having a linear dampener that includes a hydraulic shock absorber;

FIG. 4A is a side sectional view taken along line 4A-4A of FIG. 3A;

FIG. 4B is a perspective view of the first component and the second component of the linear dampener shown in FIG. 3A;

FIG. 5A is a side sectional view taken along line 5A-5A of FIG. 3B; and

FIG. 5B is a perspective view of the hydraulic shock absorber of the linear dampener shown in FIG. 3B.

The figures are not necessarily to scale and some features may be exaggerated or minimized, such as to show details of particular components. In some instances, well-known components, systems, materials or methods have not been described in detail in order to avoid obscuring the present disclosure. Therefore, specific structural and functional details disclosed herein are not to be interpreted as limiting, but merely as a basis for the claims and as a representative basis for teaching one skilled in the art to variously employ the present disclosure.

### DETAILED DESCRIPTION

The following description is merely exemplary in nature and is not intended to limit the present disclosure, application, or uses. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality. Although the figures shown herein depict an example with certain arrangements of elements, additional intervening elements, devices, features, or components may be present in actual embodiments. It should also be understood that the figures are merely illustrative and may not be drawn to scale.

As used herein, the term “vehicle” is not limited to automobiles. While the present technology is described primarily herein in connection with automobiles, the technology is not limited to automobiles. The concepts can be used in a wide variety of applications, such as in connection with aircraft, marine craft, other vehicles, and consumer electronic components.

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about”, with reference to percentages, comprises a variation of plus/minus 5%, “about”, with reference to temperatures, comprises a variation of plus/minus five degrees, and “about”, with reference to distances, comprises plus/minus 10%. In addition, disclosure of ranges includes disclosure of all values and further divided ranges within the entire range, including endpoints and sub-ranges given for the ranges. In addition, disclosure of ranges includes disclosure of all values and further divided ranges within the entire range, including endpoints and sub-ranges given for the ranges.

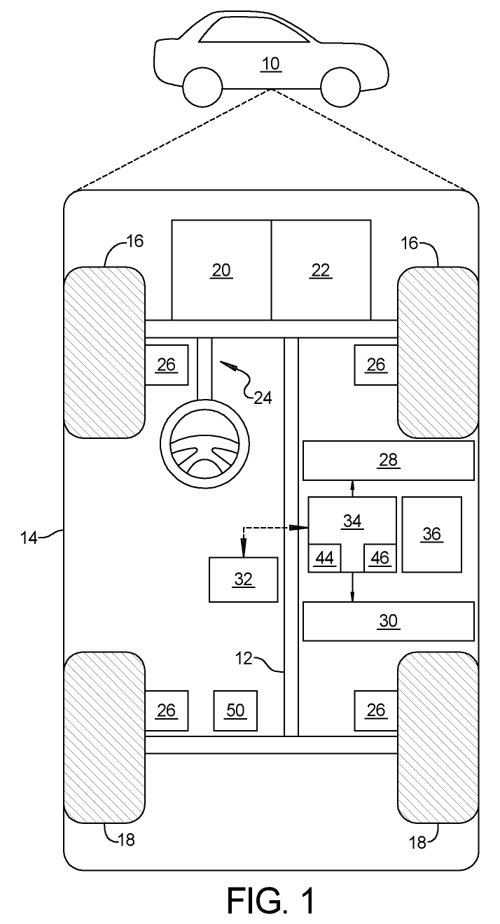

Example embodiments will now be described more fully with reference to the accompanying drawings. In accordance with an exemplary embodiment, FIG. 1 shows a vehicle 10 with an associated leaf spring shackle 50. The vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The front wheels 16 and rear wheels 18 are each rotationally coupled to the chassis 12 near a respective corner of the body 14.

As shown, the vehicle 10 generally includes a propulsion system 20, a transmission system 22, a steering system 24, a brake system 26, a sensor system 28, an actuator system 30, at least one data storage device 32, a vehicle controller 34, and a wireless communication module 36. In an embodiment in which the vehicle 10 is an electric vehicle, there may be no transmission system 22. The propulsion system 20 may, in various embodiments, include an internal combustion engine, an electric machine such as a traction motor, and/or a fuel cell propulsion system. The transmission system 22 is configured to transmit power from the propulsion system 20 to the vehicle’s front wheels 16 and rear wheels 18 according to selectable speed ratios. According to various embodiments, the transmission system 22 may include a step-ratio automatic transmission, a continuously-variable transmission, or other appropriate transmission. The brake system 26 is configured to provide braking torque to the vehicle’s front wheels 16 and rear wheels 18. The brake system 26 may, in various embodiments, include friction brakes, brake by wire, a regenerative braking system such as an electric machine, and/or other appropriate braking systems. The steering system 24 influences a position of the front wheels 16 and rear wheels 18. While depicted as including a steering wheel for illustrative purposes, in some embodiments contemplated within the scope of the present disclosure, such as for a fully autonomous vehicle, the steering system 24 may not include a steering wheel.

The sensor system 28 includes one or more sensing devices that sense observable conditions of the exterior environment and/or the interior environment of the autonomous vehicle 10. The sensing devices can include, but are not limited to, radars, lidars, global positioning systems, optical cameras, thermal cameras, ultrasonic sensors, and/or other sensors.

The vehicle controller 34 includes at least one processor 44 and a computer readable storage device or media 46. The at least one data processor 44 can be any custom made or commercially available processor, a central processing unit (CPU), a graphics processing unit (GPU), an auxiliary processor among several processors associated with the vehicle controller 34, a semi-conductor based microprocessor (in the form of a microchip or chip set), a macro-processor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the at least one data processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10.

The wireless communication module 36 is configured to wirelessly communicate information to and from other remote entities 48, such as but not limited to, other vehicles (“V2V” communication,) infrastructure (“V2I” communication), remote systems, remote servers, cloud computers, and/or personal devices. In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The vehicle controller 34 is a non-generalized, electronic control device having a preprogrammed digital computer or processor, memory or non-transitory computer readable medium used to store data such as control logic, software applications, instructions, computer code, data, lookup tables, etc., and a transceiver [or input/output ports]. Computer readable medium includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device. Computer code includes any type of program code, including source code, object code, and executable code.

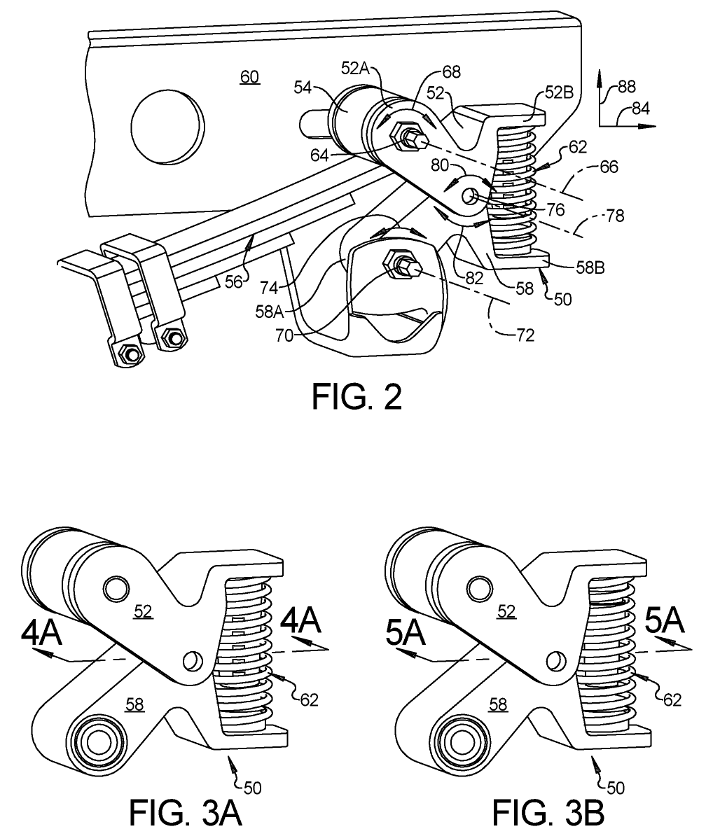

Referring to FIG. 2 a leaf spring shackle 50 for a vehicle 10, includes an upper bracket 52 adapted to be pivotally connected to a distal end 54 of a leaf spring 56 and a lower bracket 58 adapted to be pivotally connected to a frame component 60 of the vehicle 10. A linear dampening member 62 is positioned between the upper bracket 52 and the lower bracket 58. The upper bracket 52 and the lower bracket 58 are pivotally connected to one another and the linear dampening member 62 is adapted to dampen pivotal movement of the upper bracket 52 relative to the lower bracket 58. In an exemplary embodiment, the upper bracket 52 and the lower bracket 58 are stamped steel components, however, it should be understood by those skilled in the art that the upper bracket 52 and the lower bracket 58 may be manufactured by processes and made from materials not specifically disclosed herein without departing from the novel features of the present disclosure.

Referring to FIGS. 2, 3A, 3B, 4A, and 5A, the upper bracket 52 is adapted to be pivotally connected to the distal end 54 of the leaf spring 56 at a first pivotal connection 64, wherein the upper bracket 52 is pivotally moveable relative to the distal end 54 of the leaf spring 56 about a first axis 66, as indicated by arrow 68. The lower bracket 58 is adapted to be pivotally connected to the frame component 60 of the vehicle 10 at a second pivotal connection 70, wherein the lower bracket 58 is pivotally moveable relative to the frame component 60 of the vehicle 10 about a second axis 72, as indicated by arrow 74. The upper bracket 52 and the lower bracket 58 are pivotally connected to one another at a third pivotal connection 76 and are pivotally moveable relative to one another about a third axis 78 as indicated by arrows 80, 82.

The upper bracket 52 includes a first end 52A and a second end 52B, the first pivotal connection 64 adjacent the first end 52A of the upper bracket 52, wherein the first end 52A of the upper bracket 52 is pivotal about the first axis 66, as indicated by arrow 68, and moveable in both an x-direction 84, forward and backward, as indicated by arrow 86, and a z-direction 88, up and down, as indicated by arrow 90. The lower bracket 58 includes a first end 58A and a second end 58B, the second pivotal connection 70 adjacent the first end 58A of the lower bracket 58, wherein the first end 58A of the lower bracket 58 is pivotal about the second axis 72 and held stationary in both the x-direction 84 and the z-direction 88. The third pivotal connection 76 is located between the first and second ends 52A, 52B of the upper bracket 52 and between the first and second ends 58A, 58B of the lower bracket 58, wherein the third pivotal connection 76 between the upper bracket 52 and the lower bracket 58 is moveable in both the x-direction 84, as indicated by arrow 92, and the z-direction 88, as indicated by arrow 94. Wherein, movement of the first end 52A of the upper bracket 52 away from the first end 58A of the lower bracket 58, as indicated by arrow 96, pivots the upper bracket 52 and the lower bracket 58 relative to one another, as indicated by arrows 80, 82 and moves the second end 52B of the upper bracket 52 toward the second end 58B of the lower bracket 58, as indicated by arrow 98.

The linear dampening member 62 is positioned between the second end 52B of the upper bracket 52 and the second end 58B of the lower bracket 58 and is adapted to dampen movement of the second end 52B of the upper bracket 52 toward the second end 58B of the lower bracket 58, dampening movement of the first end 52A of the upper bracket 52 away from the first end 58A of the lower bracket 58. Thus, as the vehicle 10 travels down a roadway, the distal end 54 of the leaf spring 56 moves fore and aft in the x-direction 84 and up and down in the z-direction 88 as the leaf spring lengthens and shortens when the vehicle wheels 16 hit irregularities within the roadway. The dampening member 62 dampens and absorbs movement of the distal end 54 of the leaf spring 56 due to such low amplitude/high frequency bumps within the roadway, reducing perception of such bumps by passengers within the vehicle 10.

In an exemplary embodiment, the linear dampening member includes a coil spring 100 positioned between the second end 52B of the upper bracket 52 and the second end 58B of the lower bracket 58, and a dampener 102 positioned within the coil spring 100 between the second end 52B of the upper bracket 52 and the second end 58B of the lower bracket 58. In various embodiments the coil spring 100 is made from any material suitable for the applications, such as, by way of example, steel, spring steel, or any other suitable material for the application. Thus, when the vehicle 10 encounters irregularities in the roadway surface, causing deformation and movement of the leaf spring 56, movement of the second end 52B of the upper bracket 52 toward the second end 58B of the lower bracket 58 linearly compresses the linear dampening member 62, wherein the linear dampening member 62 provides linear dampening, along a vertical axis 124, of the movement of the second end 52B of the upper bracket 52 toward the second end 58B of the lower bracket 58.

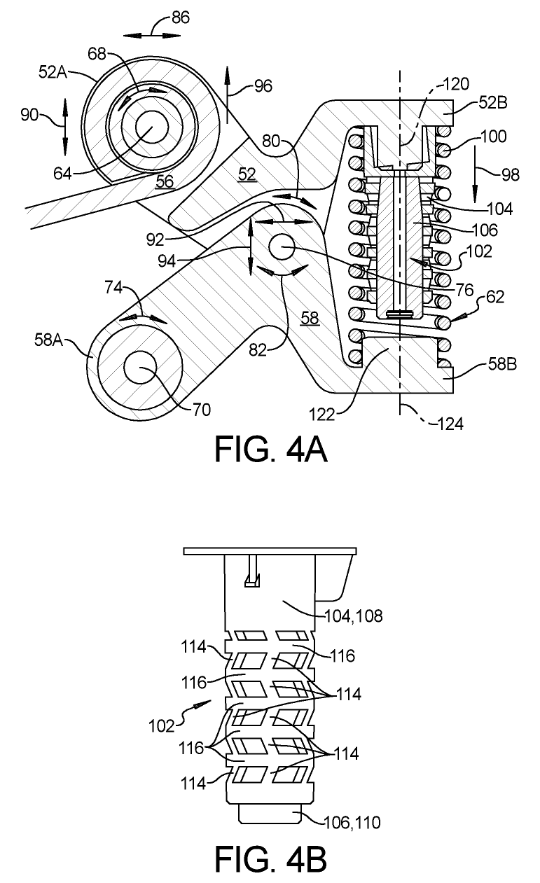

Referring to FIGS. 3A, 4A and 4B, the dampener 102 includes a first component 104 made from a dampening material and a second component 106 made from an energy absorbing material. In an exemplary embodiment, the first component 104 of the dampener 102 is a cylindrical tower 108 positioned within the coil spring 100 and made from thermoplastic urethane and the second component 106 of the dampener 102 is a column 110 positioned within the cylindrical tower 108 and made from microcellular urethane. As shown, the cylindrical tower 108 has a mesh structure with angled vertical support sections 114 interconnecting adjacent annular sections 116. The angled vertical support sections 114 are adapted to allow easier deflection of the cylindrical tower 108 under compression to readily dampen the compression of the dampener 102. Dimensional features such as length and thickness of the vertical support sections 114 can be designed to provide less or more stiffness of the cylindrical tower, allowing the dampener to be tuned for a specific application. Additionally, the stiffness, and energy absorbing characteristics of the thermoplastic urethane cylindrical tower 108 and the microcellular urethane column 110 can be tailored to tune the dampener for a specific application.

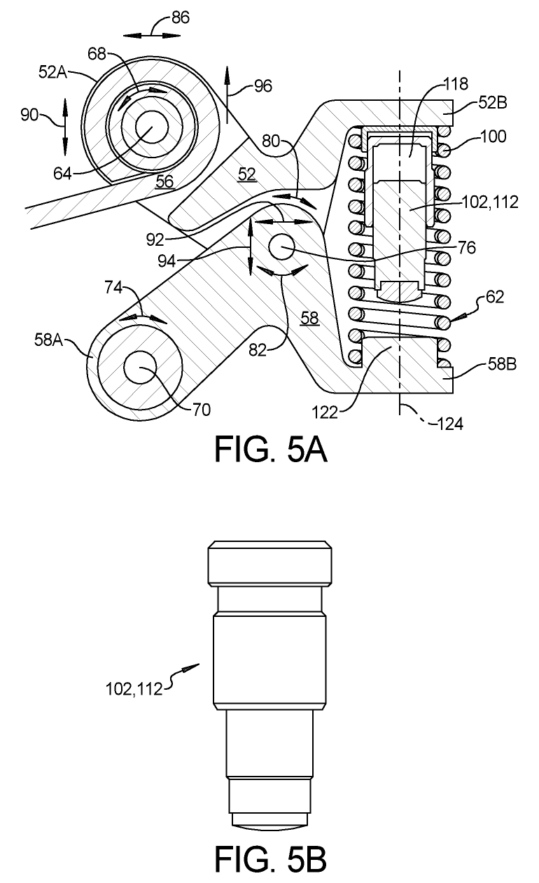

Referring to FIGS. 3B, 5A, and 5B, the dampener 102 comprises a hydraulic shock absorber 112. The hydraulic shock absorber 112 may be any type of device using a contained compressible fluid 118 to absorb energy when the dampener is compressed.

It should be understood by those skilled in the art, that other types dampening element 62 may be used without departing from the novel features of the present disclosure. Referring to FIG. 4A, in an exemplary embodiment, the second end 52B of the upper bracket 52 includes a downward projecting button 120 which engages the cylindrical tower 104 and/or the coil spring 100 to keep the linear dampener 62 aligned with and in contact with the second end 52B of the upper bracket 52, and the second end 58B of the lower bracket 58 includes an upward projecting button 122 which engages the coil spring 100 to keep the linear dampener 62 aligned with and in contact with the second end 58B of the lower bracket 58.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A leaf spring shackle for a vehicle, comprising:
an upper bracket adapted to be pivotally connected to a distal end of a leaf spring;
a lower bracket adapted to be pivotally connected to a frame component of the vehicle; and
a linear dampening member positioned between the upper bracket and the lower bracket; and
wherein, the upper bracket and the lower bracket are pivotally connected to one another and the linear dampening member is adapted to dampen pivotal movement of the upper bracket relative to the lower bracket.

2. The leaf spring shackle of claim 1, wherein:
the upper bracket is adapted to be pivotally connected to the distal end of the leaf spring at a first pivotal connection, wherein the upper bracket is pivotally moveable relative to the distal end of the leaf spring about a first axis;
the lower bracket is adapted to be pivotally connected to the frame component of the vehicle at a second pivotal connection, wherein the lower bracket is pivotally moveable relative to the frame of the vehicle about a second axis; and
the upper bracket and the lower bracket are pivotally connected to one another at a third pivotal connection and are pivotally moveable relative to one another about a third axis.

3. The leaf spring shackle of claim 2, wherein:
the upper bracket includes a first end and a second end, the first pivotal connection adjacent the first end of the upper bracket;
the lower bracket includes a first end and a second end, the second pivotal connection adjacent the first end of the lower bracket;
the third pivotal connection located between the first and second end of the upper bracket and between the first and second end of the lower bracket;
wherein, movement of the first end of the upper bracket away from the first end of the lower bracket pivots the upper backet and the lower bracket relative to one another and moves the second end of the upper bracket toward the second end of the lower bracket.

4. The leaf spring shackle of claim 3, wherein the linear dampening member is positioned between the second end of the upper bracket and the second end of the lower bracket and is adapted to dampen movement of the second end of the upper bracket toward the second end of the lower bracket, dampening movement of the first end of the upper bracket away from the first end of the lower bracket.

5. The leaf spring shackle of claim 4, wherein:
the first end of the upper bracket is pivotal about the first axis and moveable in both an x-direction, forward and backward, and a z-direction, up and down;
the first end of the lower bracket is pivotal about the second axis and held stationary in both the x-direction and the z-direction; and
the third pivotal connection between the upper bracket and the lower bracket is moveable in both the x-direction and the z-direction.

6. The leaf spring shackle of claim 5, wherein the linear dampening member includes a coil spring positioned between the second end of the upper bracket and the second end of the lower bracket, and a dampener positioned within the coil spring between the second end of the upper bracket and the second end of the lower bracket.

7. The leaf spring shackle of claim 6, wherein the coil spring is made from steel.

8. The leaf spring shackle of claim 6 wherein the dampener includes a first component made from a dampening material and a second component made from an energy absorbing material.

9. The leaf spring shackle of claim 8, wherein the first component of the dampener is a cylindrical tower positioned within the coil spring and made from thermoplastic urethane and the second component of the dampener is a column positioned within the cylindrical tower and made from microcellular urethane.

10. The leaf spring shackle of claim 6 wherein the dampener comprises a hydraulic shock absorber.

11. The leaf spring shackle of claim 6, wherein movement of the second end of the upper bracket toward the second end of the lower bracket linearly compresses the linear dampening member.

12. The leaf spring shackle of claim 6, wherein the upper bracket and the lower bracket are stamped steel components.

13. A leaf spring assembly for a vehicle, comprising:
a leaf spring; and
a leaf spring shackle adapted to connect the leaf spring to a frame component of the vehicle, the leaf spring shackle including:
a stamped steel upper bracket adapted to be pivotally connected to a distal end of the leaf spring;
a stamped steel lower bracket adapted to be pivotally connected to a frame component of the vehicle; and
a linear dampening member positioned between the upper bracket and the lower bracket; and
wherein, the upper bracket and the lower bracket are pivotally connected to one another and the linear dampening member is adapted to dampen pivotal movement of the upper bracket relative to the lower bracket.

14. The leaf spring assembly of claim 13, wherein:
the upper bracket is adapted to be pivotally connected to the distal end of the leaf spring at a first pivotal connection, wherein the upper bracket is pivotally moveable relative to the distal end of the leaf spring about a first axis;
the lower bracket is adapted to be pivotally connected to the frame component of the vehicle at a second pivotal connection, wherein the lower bracket is pivotally moveable relative to the frame of the vehicle about a second axis; and
the upper bracket and the lower bracket are pivotally connected to one another at a third pivotal connection and are pivotally moveable relative to one another about a third axis.

15. The leaf spring assembly of claim 14, wherein:
the upper bracket includes a first end and a second end, the first pivotal connection adjacent the first end of the upper bracket;
the lower bracket includes a first end and a second end, the second pivotal connection adjacent the first end of the lower bracket;
the third pivotal connection located between the first and second end of the upper bracket and between the first and second end of the lower bracket;
wherein, movement of the first end of the upper bracket away from the first end of the lower bracket pivots the upper backet and the lower bracket relative to one another and moves the second end of the upper bracket toward the second end of the lower bracket.

16. The leaf spring assembly of claim 15, wherein the linear dampening member is positioned between the second end of the upper bracket and the second end of the lower bracket, wherein movement of the second end of the upper bracket toward the second end of the lower bracket linearly compresses the linear dampening member and the linear dampening member is adapted to linearly dampen movement of the second end of the upper bracket toward the second end of the lower bracket, dampening movement of the first end of the upper bracket away from the first end of the lower bracket.

17. The leaf spring assembly of claim 16, wherein:
the first end of the upper bracket is pivotal about the first axis and moveable in both an x-direction, forward and backward, and a z-direction, up and down;
the first end of the lower bracket is pivotal about the second axis and held stationary in both the x-direction and the z-direction; and
the third pivotal connection between the upper bracket and the lower bracket is moveable in both the x-direction and the z-direction;
wherein the linear dampening member includes a steel coil spring positioned between the second end of the upper bracket and the second end of the lower bracket, and a dampener positioned within the coil spring between the second end of the upper bracket and the second end of the lower bracket.

18. The leaf spring shackle of claim 17 wherein the dampener includes a cylindrical tower positioned within the coil spring and made from thermoplastic urethane and a column positioned within the cylindrical tower and made from microcellular urethane.

19. The leaf spring shackle of claim 6 wherein the dampener comprises a hydraulic shock absorber.

20. A vehicle having a leaf spring shackle for supporting a leaf spring thereon, the leaf spring shackle including:
a stamped steel upper bracket adapted to be pivotally connected to the distal end of the leaf spring at a first pivotal connection, wherein the upper bracket is pivotally moveable relative to the distal end of the leaf spring about a first axis, the upper bracket including a first end and a second end, the first pivotal connection adjacent the first end of the upper bracket and moveable in both an x-direction, forward and backward, and a z-direction, up and down;
a stamped steel lower bracket adapted to be pivotally connected to the frame component of the vehicle at a second pivotal connection, wherein the lower bracket is pivotally moveable relative to the frame of the vehicle about a second axis, the lower bracket including a first end and a second end, the second pivotal connection adjacent the first end of the lower bracket and held stationary in both the x-direction and the z-direction;
the upper bracket and the lower bracket pivotally connected to one another at a third pivotal connection and pivotally moveable relative to one another about a third axis, the third pivotal connection located between the first and second end of the upper bracket and between the first and second end of the lower bracket and moveable in both the x-direction and the z-direction; and
a linear dampening member positioned between the upper bracket and the lower bracket and including a steel coil spring and a dampener positioned within the coil spring; and
wherein, movement of the first end of the upper bracket away from the first end of the lower bracket moves the second end of the upper bracket toward the second end of the lower bracket and linearly compresses the linear dampening member, wherein the linear dampening member is adapted to linearly dampen movement of the second end of the upper bracket toward the second end of the lower bracket, dampening movement of the first end of the upper bracket away from the first end of the lower bracket.
